(19) United States
(12) Patent Application Publication
(10) Pub. No.: US 2025/0144965 A1
(43) Pub. Date: May 8, 2025

(54) TIRE PRESSURE MONITORING SYSTEM WAKE-UP DEVICE

(71) Applicant: CHIA-TE CHIEN, TAIPEI CITY (TW)

(72) Inventor: CHIA-TE CHIEN, TAIPEI CITY (TW)

(21) Appl. No.: 18/938,283

(22) Filed: Nov. 6, 2024

(30) Foreign Application Priority Data
Nov. 8, 2023 (TW) 112143019

(51) Int. Cl. B60C 23/04

(52) U.S. Cl. CPC B60C 23/0461; B60C 23/0444; B60C 23/0474

(57) ABSTRACT

A tire pressure monitoring system wake-up device is electrically connected to multiple tire pressure sensors and mutually transmits signals. The wake-up device includes an antenna unit, a main control board unit, a power supply unit, a radio frequency switch unit, and a database unit. After the antenna unit receives a signal which is then sent to the receiving module of the radio frequency switch unit. The receiving module processes and computes the received signal, it indirectly sends it to the database unit for comparison via the transmitting module. When the signal sent by the transmitting module matches the data range within the database unit, the main control board unit sends the comparison result back to the antenna unit. Upon receiving the returned signal, the antenna unit activates or does not activate each tire pressure sensor to detect and operate on each tire based on the content of the signal.

### BACKGROUND OF THE INVENTION

### 1. Fields of the invention

The present invention relates to a technology applied in the field of vehicles, and more particularly, to a tire pressure monitoring system (TPMS) wake-up device.

### 2. Descriptions of Related Art

The use of tire pressure monitoring systems (TPMS) provides a certain level of protection for driving safety. Users can monitor each tire through the TPMS, maintaining constant vigilance over tire conditions and ensuring driving safety.

However, typical TPMS are connected to a display screen of vehicles, showing relevant data such as tire pressure, temperature, and rotation speed for each tire, allowing users to observe and pay attention. But not all tires are always in a problematic condition, and when the vehicle is not in motion, the tires do not experience significant wear. Therefore, most current TPMS operate in a constant mode, continuously monitoring each tire. This behavior undoubtedly accelerates the power consumption of the TPMS, and the uninterrupted operation also rapidly shortens its lifespan, leading to increased costs.

The present invention intends to provide a tire pressure monitoring system wake-up device to eliminate the shortcomings mentioned above.

### SUMMARY OF THE INVENTION

The present invention relates to a tire pressure monitoring system wake-up device wherein wake-up device is wirelessly or wiredly electrically connected to multiple tire pressure sensors and mutually transmits signals. The wake-up device comprises an antenna unit, a main control board unit, a power supply unit, a radio frequency switch unit, and a database unit. The antenna unit, the main control board unit, the power supply unit, the radio frequency switch unit, and the database unit are interconnected. The power supply unit supplies power to the main control board unit and the antenna unit for operation. The radio frequency switch unit is connected to the antenna unit and includes a receiving module and a transmitting module. The receiving module receives signals transmitted by the antenna unit and processes the signals. The transmitting module sends the signals to the database unit for comparison. The main control board unit controls the power supply unit to supply and shutdown the power, controls the radio frequency switch unit to be turned on and turned off, and manages the database unit to operate comparison operations.

When the antenna unit receives a signal, the antenna unit transmits the signal to the receiving module of the radio frequency switch unit within the wake-up device. After the receiving module receives and processes the signal, the signals is indirectly sent to the database unit for comparison via the transmitting module. When the signal sent by the transmitting module matches a data range within the database unit, the main control board unit sends comparison result back to the antenna unit.

When the antenna unit receives the signal, the antenna unit activates or does not activate each tire pressure sensor to detect and operate on each tire based on a content of the signal.

The primary object of the present invention is to provide a tire pressure monitoring system (TPMS) for vehicles that only needs to detect each tire when necessary, rather than continuously. When detection is not necessary, the TPMS can be temporarily stopped from operating. This helps conserve battery usage and extend the operational lifespan of the device.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a block diagram illustrating the structure of the wake-up device of the present invention.

### DETAILED DESCRIPTION OF THE PREFERRED EMBODIMENT

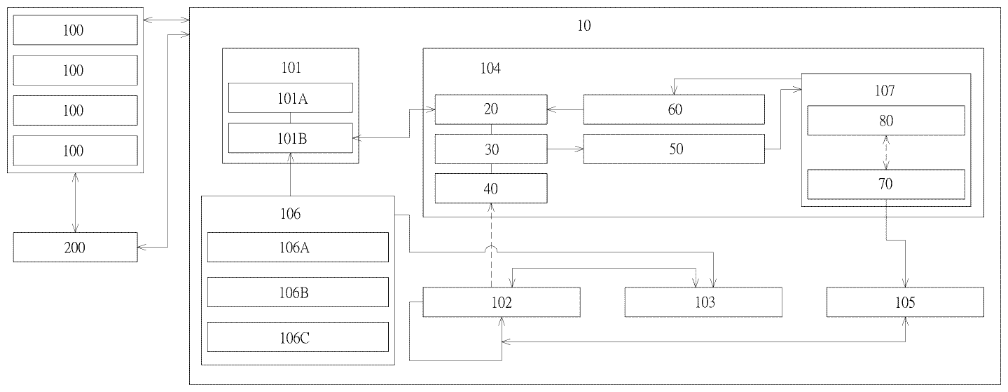

Referring to FIG. 1, the tire pressure monitoring system wake-up device of the present invention comprises an antenna unit 101, a main control board unit 102, a power supply unit 103, a radio frequency switch unit 104, and a database unit 105. The wake-up device 10 is installed to vehicles, and wirelessly or wiredly electrically connected to multiple tire pressure sensors 100 and mutually transmits signals. The antenna unit 101, the main control board unit 102, the power supply unit 103, the radio frequency switch unit 104, and the database unit 105 are interconnected. The power supply unit 103 supplies power to the main control board unit 102 and the antenna unit 101 for operation. The radio frequency switch unit 104 is connected to the antenna unit 101 and includes a receiving module 20 and a transmitting module 30. The receiving module 20 receives signals transmitted by the antenna unit 101 and processes the signals. The transmitting module 30 sends the signals to the database unit 105 for comparison. The main control board unit 102 controls the power supply unit 103 to supply and shutdown the power. The main control board unit 102 also controls the radio frequency switch unit 104 to be turned on and turned off, and manages the database unit 105 to operate comparison operations.

When the antenna unit 101 receives a signal, the antenna unit 101 transmits the signal to the receiving module 20 of the radio frequency switch unit 104 within the wake-up device 10. After the receiving module 20 receives and processes the signal, the signals is indirectly sent to the database unit 105 for comparison via the transmitting module 30. When the signal sent by the transmitting module 30 matches a data range within the database unit 105, the main control board unit 102 sends comparison result back to the antenna unit 101. When the antenna unit 101 receives the signal, the antenna unit 101 activates or does not activate each tire pressure sensor 100 to detect and operate on each tire based on a content of the signal.

The signals received by the antenna unit 101 can be distinguished as external signals and non-external active signals. External signals refer to signals (frequencies) emitted by various electrical and electronic devices in the environment. Non-external active signals are those generated by the control devices on the vehicle based on the judgment of the user or the wake-up device 10. To avoid activating each tire pressure sensor 100 when the antenna unit 101 receives both external and active signals, the database unit 105 is used for comparison to filter and screen out external signals. Since external signals inherently contain noise, the presence of noise can be used to determine whether the signal received by the antenna unit 101 is external or active. This prevents the situation where each tire pressure sensor 100 is activated at any time.

The wake-up device 10 of the present invention can be set up in three ways on a vehicle. The first is as an independent component device. The second involves multiple wake-up devices 10, each installed within individual tire pressure sensors 100. The third option is installation inside a display screen 200 within the vehicle (for convenient user control and activation). The choice of installation location for the wake-up device 10 can be based on user's needs. As shown in FIG. 1, the setup of the radio frequency switch unit 104 is primarily designed to convert the received signals to facilitate subsequent comparison with the data range in the database unit 105.

The radio frequency switch unit 104 includes a switch module 40, an initial signal conversion module 50, and a final signal conversion module 60. After the receiving module 20 receives the signal transmitted by the antenna unit 101, the signal transmitted by the antenna unit 101 is converted from analog to digital by the initial signal conversion module 50. The digital signal is then compared with the data range set in the database unit 105, and a result of signal comparison is transmitted to the final signal conversion module 60. The final signal conversion module 60 then converts the result of signal comparison from digital back to analog. The result of the signal comparison with the database unit 105 is simultaneously transmitted to the main control board unit 102. The main control board unit 102 controls the switch module 40 to be turned on or turned off. When the switch module 40 is turned on, the result of signal comparison that is analog-converted is transmitted to the antenna unit 101 via the transmitting module 30 to emit a signal. This mode allows for the optimization and processing of signals containing noise, as shown in FIG. 1.

In order to prevent each antenna unit 101 from accepting external radio frequencies that might affect the main control, the wake-up device 10 includes a radio frequency detection unit 107. The radio frequency detection unit 107 is connected to the initial signal conversion module 50 of the radio frequency switch unit 104 and the database unit 105. The radio frequency detection unit 107 adjusts and filters the signal converted by the initial signal conversion module 50. The antenna unit 101 includes an antenna 101A and an antenna tuner 101B. The antenna 101A receives signals and transmits the signals to the antenna tuner 101B, and the antenna tuner 101B quantizes the signals received by the antenna 101A into digital signals and transmits them to the receiving module 20 of the radio frequency switch unit 104.

After comparing the signals of the present invention with the data in the database unit 105, it primarily conducts multiple comparisons within each second. The majority of these comparison results are then used to determine whether it is an active signal or an external signal based on conditions such as timing and continuity. The method of judgment is not restricted.

As shown in FIG. 1, when the signal is determined not an active signal but an external one, in order to definitively distinguish it from active signals, the user or the main control board unit 102 can make adjustments. For example, they can first raise the standard for signals received by the antenna unit, or adjust the power supply from the power supply unit 103, to enable a clear judgment. Therefore, the wake-up device 10 includes a control selection unit 106 which is connected to the power supply unit 103 and the antenna unit 101. The control selection unit 106 controls an amount of power provided by the power supply unit 103 that is transmitted to the main control board unit 102, and the power required by the antenna unit 101. The control selection unit 106 includes a GPIO Control module 106A (General-purpose input/output interface control module, GPIO: General-purpose input/output), a MIPI Control module 106B (Mobile Industry

Processor Interface control module, MIPI: Mobile Industry Processor Interface), and a Voltage Control module 106C (voltage control module). The user or the main control board unit 102 can choose any of the aforementioned control modes to limit the power connection between the power supply unit 103 and the antenna unit 101. By restricting factors such as power and voltage, they can limit the strength of signal reception by the antenna unit 101. This helps to ensure that the antenna unit 101 can receive the desired radio frequency range, guaranteeing that each tire pressure sensor 100 is only activated when it receives the correct signal.

Finally, to ensure the effective reception of active signals, the antenna unit 101 includes an antenna 101A and an antenna tuner 101B. The antenna 101A receives signals and transmits the signals to the antenna tuner 101B, and the antenna tuner 101B quantizes the signals received by the antenna 101A into digital signals and transmits them to the receiving module 20 of the radio frequency switch unit 104.

While we have shown and described the embodiment in accordance with the present invention, it should be clear to those skilled in the art that further embodiments may be made without departing from the scope of the present invention.

What is claimed is:

1. A tire pressure monitoring system wake-up device comprising:
an antenna unit (101), a main control board unit (102), a power supply unit (103), a radio frequency switch unit (104), and a database unit (105), the wake-up device (10) wirelessly or wiredly electrically connected to multiple tire pressure sensors (100) and mutually transmits signals, the antenna unit (101), the main control board unit (102), the power supply unit (103), the radio frequency switch unit (104), and the database unit (105) being interconnected, the power supply unit (103) supplying power to the main control board unit (102) and the antenna unit (101) for operation, the radio frequency switch unit (104) connected to the antenna unit (101) and including a receiving module (20) and a transmitting module (30), the receiving module (20) receiving signals transmitted by the antenna unit (101) and processing the signals, the transmitting module (30) sending the signals to the database unit (105) for comparison;
the main control board unit (102) controlling the power supply unit (103) to supply and shutdown the power, controlling the radio frequency switch unit (104) to be turned on and turned off, and managing the database unit (105) to operate comparison operations, and
when the antenna unit (101) receives a signal, the antenna unit (101) transmits the signal to the receiving module (20) of the radio frequency switch unit (104) within the wake-up device (10), after the receiving module (20) receives and processes the signal, the signals is indirectly sent to the database unit (105) for comparison via the transmitting module (30), when the signal sent by the transmitting module (30) matches a data range within the database unit (105), the main control board unit (102) sends comparison result back to the antenna unit (101), when the antenna unit (101) receives the signal, the antenna unit (101) activates or does not activate each tire pressure sensor (100) to detect and operate on each tire based on a content of the signal.

2. The tire pressure monitoring system wake-up device as claimed in claim 1, wherein the wake-up device (10) is an independent component, or comprises multiple units separately installed within each tire pressure sensor (100), or the wake-up device (10) is installed inside a display screen (200) within a vehicle.

3. The tire pressure monitoring system wake-up device as claimed in claim 1, wherein the radio frequency switch unit (104) includes a switch module (40), an initial signal conversion module (50), and a final signal conversion module (60), after the receiving module (20) receives the signal transmitted by the antenna unit (101), the signal transmitted by the antenna unit (101) is converted from analog to digital by the initial signal conversion module (50), the digital signal is then compared with the data range set in the database unit (105), and a result of signal comparison is transmitted to the final signal conversion module (60), the final signal conversion module (60) then converts the result of signal comparison from digital back to analog, the result of the signal comparison with the database unit (105) is simultaneously transmitted to the main control board unit (102), the main control board unit (102) controls the switch module (40) to be turned on or turned off, when the switch module (40) is turned on, the result of signal comparison that is analog-converted is transmitted to the antenna unit (101) via the transmitting module (30) to emit a signal.

4. The tire pressure monitoring system wake-up device as claimed in claim 3, wherein the wake-up device (10) includes a radio frequency detection unit (107V, the radio frequency detection unit (107) is connected to the initial signal conversion module (50) of the radio frequency switch unit (104) and the database unit (105), the radio frequency detection unit (107) adjusts and filters the signal converted by the initial signal conversion module (50).

5. The tire pressure monitoring system wake-up device as claimed in claim 4, wherein the radio frequency detection unit (107) includes a strength filtering analysis module (70) and a frequency band selection module (80), the strength filtering analysis module (70) filters out noise from the signal converted by the initial signal conversion module (50), analyzes and categorizes frequency bands, the frequency band selection module (80) then selects the frequency bands to be compared with the database unit (105).

6. The tire pressure monitoring system wake-up device as claimed in claim 1, wherein the wake-up device (10) includes a control selection unit (106) which is connected to the power supply unit (103) and the antenna unit (101), the control selection unit (106) controls an amount of power provided by the power supply unit (103) that is transmitted to the main control board unit (102), and the power required by the antenna unit (101).

7. The tire pressure monitoring system wake-up device as claimed in claim 6, wherein the control selection unit (106) includes a GPIO Control module (106A) (General-purpose input/output interface control module, GPIO: General-purpose input/output), a MIPI Control module (106B) (Mobile Industry Processor Interface control module, MIPI: Mobile Industry Processor Interface), and a Voltage Control module (106C) (voltage control module).

8. The tire pressure monitoring system wake-up device as claimed in claim 1, wherein the antenna unit (101) includes an antenna (101A) and an antenna tuner (101B), the antenna (101A) receives signals and transmits the signals to the antenna tuner (101B), the antenna tuner (101B) quantizes the signals received by the antenna (101A) into digital signals and transmits them to the receiving module (20) of the radio frequency switch unit (104).
